(19) United States
(12) Patent Application Publication
(10) Pub. No.: US 2010/0072945 A1
(43) Pub. Date: Mar. 25, 2010

(54) CHARGING SET FOR AN ACCUMULATOR

(75) Inventors: Steffen Tiede, Herrenberg (DE); Juergen Gairing, Stuttgart (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/467,846

(22) Filed: May 18, 2009

(30) Foreign Application Priority Data
Sep. 22, 2008 (DE) 102008042267.3

(51) Int. Cl. H02J 7/00

(52) U.S. Cl. 320/107

(57) ABSTRACT

In a charging set for an accumulator with a housing, which has a charging receptacle for the accumulator, and with a power cable for connecting the charging set to a power grid, provision is made on said housing for at least a first switching element, which can be actuated in order to activate the connection of the charging set to the power grid via the power cable for the power supply to said charging set.

### TECHNICAL FIELD

The present invention relates to a charging set for an accumulator with a housing, which has a charging receptacle for the accumulator, and with a power cable for connecting the charging set to a power grid.

### BACKGROUND

Such charging sets are designed for recharging electrochemical energy storages, so called accumulators, which consist as a rule of individual storage cells connected together into packs or modules. They are therefore denoted as accumulator packs or accumulator modules. The charging sets can be connected as a rule to power grids, which usually are operated in the AC voltage range of 115-240 V.

The startup of a commensurate charging set initially entails connecting said set to the power grid via the power cable. The actual charging process is then activated by inserting an accumulator into a charging receptacle associated with the charging set. After the accumulator has been charged, said accumulator is removed from the charging receptacle, whereupon the connection of the charging set to the power grid can be broken. The charging set can alternatively stay connected to the power grid under open circuit voltage conditions.

A disadvantage of the technical field is that conventional charging sets do not only consume energy when recharging accumulators but also if they are connected to the power grid under open circuit voltage conditions when the accumulator is not being recharged. This is especially the case when the power grid is continually connected to the charging sets and leads to an undesirable energy consumption and consequently to preventable energy consumption costs. The extent of the undesirable energy consumption and the thereby associated preventable energy consumption costs is dependent on the number and the capacity of the charging sets and becomes correspondingly greater, the greater the number is of high-capacity charging sets continually connected to the power grid. For example, conventional charging sets used for recharging accumulators with a capacity of 2 Ah require approximately 1.5 W of energy under open circuit voltage conditions.

### SUMMARY

A task of the invention is therefore to provide a new charging set, whose energy consumption is at least reduced under open circuit voltage conditions.

This problem is solved by a charging set for an accumulator with a housing, which has a charging receptacle for the accumulator and with a power cable for connecting the charging set to a power grid. A first switching element is provided on the housing, which can be actuated in order to activate the connection of the charging set to the power grid for the supply of power to said charging set via the power cable.

The invention consequently makes it possible to deenergize the charging set, which is connected to the power grid, under open circuit voltage conditions. In so doing, the power supply to the charging set can according to the invention only be activated by means of an actuation of the first switching element. In this way, an undesirable energy consumption under open circuit voltage conditions is prevented, and for this reason unnecessary associated energy consumption costs are consequently avoided.

According to one embodiment, the first switching element is a rocker switch or a pressure switch.

The charging set according to the invention can consequently be implemented by using a cost effective switching element in a simple manner.

The first switching element is preferably disposed in the region of the charging receptacle. The first switching element can preferably be actuated by inserting the accumulator into the charging receptacle.

Hence, the invention allows for a simple configuration as well as an uncomplicated handling of the charging set.

The charging receptacle can be configured as a receiving slot. In so doing, the first switching element is preferably disposed in the receiving slot. As an alternative to this, the charging receptacle can be configured as a receiving recess. In so doing, the first switching element is preferably disposed in the receiving recess.

The invention consequently allows for a simple and uncomplicated configuration of charging sets, which are diversely implemented and in which an arrangement of the first switching element can result in each case as a function of an associated embodiment of the charging receptacle.

According to one embodiment, a second switching element is provided on the housing, which can be actuated in order to activate a charging process for recharging the accumulator.

The charging process can consequently be activated independent of the connection between the charging set and the power grid.

The first switching element can have a mechanical, optical, inductive and/or capacitive switch.

The invention consequently allows for a simple and efficient configuration of the first switching element.

### BRIEF DESCRIPTION OF THE DRAWINGS

The invention is explained in detail in the following description using one example of embodiment depicted in the drawings.

FIG. 1 shows a first embodiment of a charging set with an accumulator according to the invention,

FIG. 2 shows an enlarged view of the charging receptacle of the charging set from FIG. 1; and

FIG. 3 shows a second embodiment of a charging set with an accumulator, which is connected to a power tool, according to the invention.

### DETAILED DESCRIPTION

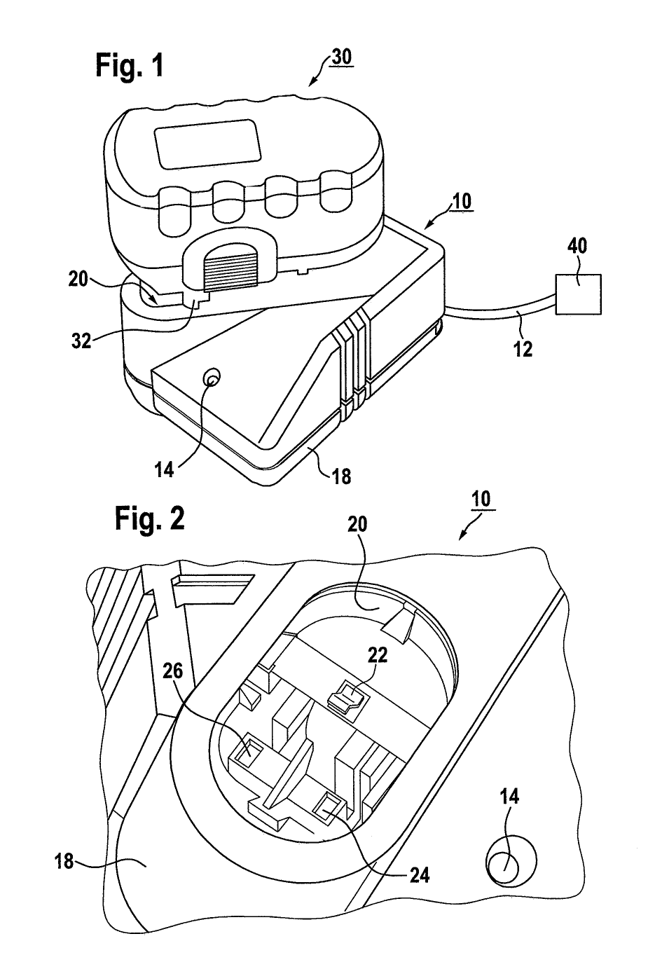

FIG. 1 shows a first embodiment of a charging set 10 for recharging an accumulator 30 during the charge mode. The accumulator 30 has by way of example a rod-shaped interface element 32 with contact elements for contacting associated counter-contact elements (24 and 26 in FIG. 2) of the charging set 10.

According to one embodiment, the accumulator comprises a plurality of storage cells, which are interconnected in an accumulator pack or module, wherein the accumulator cells can be from an arbitrary type of accumulator, as, for example, NiCd, NiMh and Li-ion. The construction of the accumulator 30 as well as a possible configuration of the rod-shaped interface element 32 is, however, not a constituent of the present invention, so that a more detailed description of them is avoided here for the sake of brevity. The accumulator 30 in particular can be configured according to one embodiment of the invention as a conventional accumulator.

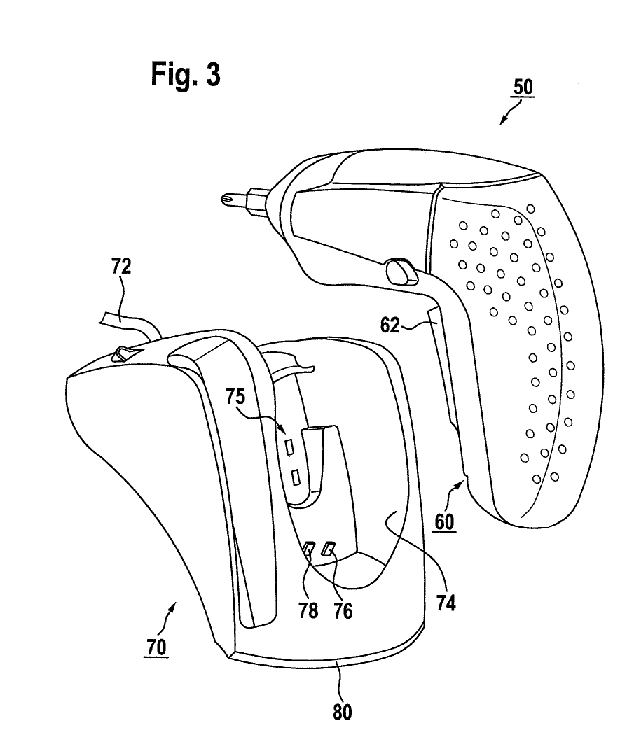

The accumulator 30 preferably serves to supply power to an electric motor designed to drive a power tool and is used, for example, in a cordless drill and/or a cordless screwdriver (50 in FIG. 3). It is, however, to be noted that the use of the accumulator 30 for the power supply of a power tool is only described for the sake of example. The use of the accumulator 30 is, however, not limited to this application. In fact the accumulator 30 can be used in many different devices, for example in a stationary energy storage or in an energy storage in motor vehicles. Modifications of this kind and others as well as variations are possible within the scope of the present invention.

The charging set 10 has a housing 18, upon which a charging receptacle 20 for receiving the accumulator 30 is provided as well as a power cable 12 for providing a connection to a power grid 40, which is schematically depicted. The power grid 40 is preferably operated in the AC voltage range of 115-240V. It is, however, to be noted that the charging set 10 can also be configured in an application specific and accumulator specific fashion for power grids, which are operated in other voltage ranges, for example in the DC voltage range of 12V. Modifications of this kind and additional ones as well as variations are possible within the scope of the present invention.

Furthermore the charging set 10 can optionally have a function display 14. Said display is configured by way of example as a LED lamp in FIG. 1, which, for example, only then illuminates if the charging set 10 is in charge mode, i.e. if a corresponding charging process is taking place.

FIG. 2 clarifies the charging receptacle 20 provided in the housing 18 of the charging set 10 of FIG. 1 and the function display 14 that is configured as an LED lamp. The charging receptacle 20 is configured by way of example as a receiving slot, wherein counter contact elements 24, 26 for contacting the contact elements provided on the interface element 32 of the accumulator 30 from FIG. 1 are disposed.

According to one embodiment, provision is made for a switching element 22 in the region of the charging set 20, said element 22 serving as stated below to activate, respectively deactivate, the connection between the charging set 10 and the power grid 40 of FIG. 1, respectively a section of the power grid associated with the charging set 10. Provision can furthermore be made for an additional switching element (78 in FIG. 3) in the region of the charging set 20 as described below with regard to FIG. 3, said element 78 serving to activate a corresponding charging process of the accumulator 30.

As is shown in FIG. 2, the switching element 22 is preferably disposed in the receiving slot, which comprises the charging receptacle 20, and can be activated via the interface element 32 of the accumulator 30 of FIG. 1. The switching element 22 is, for example, configured as a rocker or a pressure switch or as a simple contact and preferably protected, in particular from dust, by suitable measures in order to prevent a penetration of foreign bodies into the charging set 10.

It is to be noted that the configuration of the switching element 22 is described as a rocker or a pressure switch, respectively as a mechanical switch, merely by way of example, and this is not to be understood as a limitation of the invention. In fact, a mechanical switch as well as another switch, for example an optical, inductive and/or capacitive switch, can be used when implementing the switching element. Such modifications and additional ones as well as variations are possible within the scope of the present invention.

During operation, the charging set 10 of FIGS. 1 and 2 is initially connected to the power grid 40 via the power cable 12. The interface element 32 of the accumulator 30 is then inserted into the charging receptacle 20. On the one hand, the contact elements provided on the interface element 32 thereby contact the associated counter contact elements 24, 26 of the charging set 10. On the other hand, the interface element 32 actuates the switching element 22, the connection of the charging set 10 being activated to the power grid 40, respectively to an associated section of the power grid, for the supply of power to the charging set 10 via the power cable 12. The LED lamp 14 illuminates, for example, for the purpose of signaling a corresponding charge mode, respectively the implementation of a charging process. During this charging process, the accumulator 30 is recharged via the contact elements provided on the interface element 32 and the associated counter contact elements 24, 26 of the charging set 10.

Upon completion of the charging process, the LED lamp 14 is preferably switched off. The accumulator 30 can then be removed from the charging set 10 in order, for example, to be connected to drive an associated power tool, the charging set 10, respectively an associated section of the power grid, being deenergized by a reactuation, respectively an enabling, of the switching element 22.

FIG. 3 shows a second embodiment of a charging set 70 for recharging an accumulator battery 60 under open circuit voltage conditions. The accumulator 60 has by way of example an interface element 62 with contact elements for contacting associated counter contact elements 75 of the charging set 70.

As can be seen in FIG. 3, the accumulator 70 serves the purpose of supplying power to an electric motor for the actuation of a power tool 50, which is configured by way of example as a cordless screwdriver. According to one embodiment, the accumulator 60 is an integral part of the cordless screwdriver 50. As an alternative to this, said accumulator 60 can, however, also be embodied as a separate component, as, for example, the accumulator 30 of FIG. 1. Such modifications as well as others and variations of the embodiment are possible within the scope of the present invention.

The charging set 70 has a housing 80, upon which a charging receptacle 74 for receiving the accumulator 60 is provided, as well as a power cable 72 for the connection to a suitable power grid, for example power grid 40 of FIG. 1. The charging set 74 is configured by way of example as a receiving recess, wherein the counter contact elements 75 are disposed. This receiving recess is preferably configured in such a way that the cordless screwdriver 50 is placed with the accumulator 60 into the receiving recess for recharging, i.e. the cordless screwdriver 50 is also at least partially contained therein during the charge mode.

According to one embodiment, a first switching element 76 is provided in the region of the charging receptacle 74, said switching element 76 serving to activate, respectively deactivate, the connection between the charging set 70 and a power grid, respectively a section of the power grid associated with the charging set 70. A second switching element 76, which serves to activate a corresponding charging process of the accumulator 60, is furthermore provided in the region of the charging receptacle 74. As can be seen in FIG. 3, the first and the second switching elements 76, 78 are preferably disposed in the receiving recess, which comprises the charging receptacle 74 and can be actuated via the interface element 62 of the accumulator 60. In so doing, the first and/or second switching element 76, 78 can be configured as a rocker or pressure switch or as a simple contact and are preferably protected in particular from dust by suitable measures in order to prevent a penetration of foreign bodies into the charging set 70.

The operation of the charging set 70 essentially corresponds to the operation of the charging set 10 of FIGS. 1 and 2 so that the present application can forego a detailed description. It is, however, to be noted that as already mentioned above, at least a part of the cordless screwdriver 50 is contained in the charging receptacle 74 with the accumulator 60 when the charging set 70 is in charge mode.

1. A charging set for an accumulator, comprising:
a housing including a charging receptacle for the accumulator, a power cable for connecting the charging set to a power grid, and at least a first switching element that when actuated activates the connection of the charging set to the power grid via the power cable to provide power to the charging set.

2. The charging set of claim 1, wherein the first switching element is a rocker or a pressure switch.

3. The charging set of claim 1, wherein the first switching element is disposed in a region of the charging receptacle.

4. The charging set of claim 3, wherein the first switching element is actuated by inserting the accumulator into the charging receptacle.

5. The charging set of claim 4, wherein the charging receptacle is configured as a receiving slot.

6. The charging set of claim 5, wherein the first switching element is disposed in the receiving slot.

7. The charging set of claim 4, wherein the charging receptacle is configured as a receiving recess.

8. The charging set of claim 7, wherein the first switching element is disposed in the receiving recess.

9. The charging set of claim 1, wherein a second switching element is provided on the housing that when actuated activates a charging process for recharging the accumulator.

10. The charging set of claim 1, wherein the first switching element has one or more of a mechanical, an optical, an inductive, and a capacitive switch.
